(19) United States
(12) Patent Application Publication
(10) Pub. No.: US 2007/0085024 A1
(43) Pub. Date: Apr. 19, 2007

(54) Fluorescence observing apparatus and fluorescence measuring apparatus

(76) Inventors: Hiroaki Kinoshita, Tokyo-to (JP); Daisuke Nishiwaki, Tokyo-to (JP)

Correspondence Address: KENYON & KENYON LLP, 1500 K STREET N.W., SUITE 700, WASHINGTON, DC, 20005, US

(21) Appl. No.: 11/386,772

(22) Filed: Mar. 23, 2006

(30) Foreign Application Priority Data
Mar. 24, 2005 (JP) 2005-086643

(51) Int. Cl. G01T 1/10

(52) U.S. Cl. 250/459.1

(57) ABSTRACT

A fluorescence observing apparatus has an illumination system for irradiating a specimen with exciting light and an observation system for observing fluorescent light emanating from the specimen. Low-fluorescence glass is used for lenses of the first and seventh lens units of an objective lens used in both the illumination system and the observation system. The low-fluorescence glass has a platinum content of less than 1 ppm. Whereby, high-precision and high-quality fluorescence observations and fluorescence measurements become possible.

This application claims benefits of Japanese Application No. 2005-86643 filed in Japan on Mar. 24, 2005, the contents of which are hereby incorporated by reference.

### BACKGROUND OF THE INVENTION

1. Field of the Invention

This invention relates to a fluorescence observing apparatus and a fluorescence measuring apparatus.

2. Description of Related Art

By recent developments of measuring instruments and apparatuses in the fields of microscopes, fluorescence microscopes, and protein and DNA analytical apparatuses, tendencies of observations and measurements in these fields are changed. In the changes of the tendencies, there are two great currents described below.

One of them is a change of the object of measurement from the observations and measurements of dead cells to those of living cells, and the advent of the post-genome era has increased the importance of the technique that allows an accurate observation and measurement of faint fluorescent light in a wide region with respect to a fluorescent probe-molecular fluorescence measurement and a simultaneous analysis of functions of living bodies by the variety of fluorescent probes.

The other is a change from an apparatus provided with only the function of observing observation information as in a conventional microscope apparatus to an apparatus provided with a means for measuring and quantifying the observation information, and accurate quantification, including a noise, has been required.

In the fluorescence observing apparatus, such as a fluorescence microscope, and the fluorescence measuring apparatus, such as a genome/protein analytical apparatus, various wavelengths are observed and measured in a wide range from ultraviolet to infrared. In particular, the fluorescence observation and measurement by three excitations, U excitation, B excitation, and G excitation, are typical. The U excitation is caused at a wavelength of 365 nm and fluorescent light of wavelength about 450 nm is observed and measured; the B excitation is caused at a wavelength of 488 nm and fluorescent light of wavelength about 540 nm are observed and measured; and the G excitation is caused at a wavelength of 550 nm and fluorescent light of wavelength about 600 nm is observed and measured.

Conventional fluorescence observing apparatuses and fluorescence measuring apparatuses are described, for example, in Japanese Patent Kokai Nos. Hei 08-320437 and Hei 08-178849. However, each of the conventional fluorescence observing apparatuses and fluorescence measuring apparatuses such as those disclosed in Japanese Patent Kokai Nos. Hei 08-320437 and Hei 08-178849 has a great effect of the noise caused by auto-fluorescence that emanates from an impurity (notably platinum colloid) contained in an optical element used in an apparatus, on a good view in the fluorescence observation and the quantification in the fluorescence measurement, and deteriorates quality.

### SUMMARY OF THE INVENTION

The fluorescence observing apparatus according to the present invention uses low-fluorescence glass for at least one optical element used in both an illumination system for irradiating a specimen with exciting light and an observation system for observing fluorescent light emanating from the specimen.

It is desirable that the fluorescence observing apparatus according to the present invention has a plurality of optical elements used in both the illumination system and the observation system so that the low-fluorescence glass is used for the most specimen-side optical element of the plurality of optical elements used in both the illumination system and the observation system.

It is desirable that the fluorescence observing apparatus according to the present invention has a plurality of optical elements used in both the illumination system and the observation system so that the low-fluorescence glass is used for the most image-side optical element of the plurality of optical elements used in both the illumination system and the observation system.

It is desirable that the fluorescence observing apparatus according to the present invention has an objective lens composed of a plurality of lens units used in both the illumination system and the observation system so that the low-fluorescence glass is used for lenses constituting a first lens unit of the objective lens.

It is desirable that the fluorescence observing apparatus according to the present invention has an objective lens composed of a plurality of lens elements used in both the illumination system and the observation system so that the low-fluorescence glass is used for lenses constituting the rearmost lens unit of the objective lens.

According to the fluorescence observing apparatus of the present invention, it is desirable that the low-fluorescence glass has a platinum content of less than 1 ppm.

According to the fluorescence observing apparatus of the present invention, it is desirable that the low-fluorescence glass is manufactured through a process of using a material containing at least platinum to melt a glass raw material and is manufactured through a process of bubbling melting glass by one of phosphorus oxychloride (POCl₃), thionyl chloride (SOCl₂), phosphorus trichloride (PCl₃), and carbon tetrachloride (CCl₄).

According to the fluorescence observing apparatus of the present invention, it is desirable that the low-fluorescence glass is manufactured by using a glass raw material in which an impurity content is kept to less than 1 ppm.

According to the fluorescence observing apparatus of the present invention, it is desirable that the low-fluorescence glass is manufactured through a process of pickling a glass raw material with acid.

The fluorescence measuring apparatus according to the present invention has the fluorescence observing apparatus of any aspect of the present invention and includes an image sensor located at the position of observation of the observation system, a digitizing conversion means for digitizing fluorescence information received by the image sensor, and a display means for displaying the fluorescence information digitized by the digitizing conversion means.

According to the present invention, it is possible to provide the fluorescence observing apparatus and the fluorescence measuring apparatus in which the effect of the noise caused by auto-fluorescence can be effectively lessened and high-precision and high-quality fluorescence observations and fluorescence measurements can be made.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a schematic explanatory view showing diagrammatically a fundamental structure of the fluorescence observing apparatus and the fluorescence measuring apparatus;

FIG. 2 is a sectional view showing an example of the arrangement of an objective lens, developed along the optical axis, used in both an illumination system and an observation system of the fluorescence observing apparatus (or the fluorescence measuring apparatus) shown in FIG. 1 to measure the intensity of auto-fluorescence in a process introducing the present invention;

FIG. 3 is a graph showing the amount of auto-fluorescence of the entire objective lens on the basis of the degree of contribution of the auto-fluorescence from each lens unit of the objective lens arranged without using low-fluorescence glass for the first and seventh lens units (a relative relationship of the intensity of the auto-fluorescence); and

FIG. 4 is a graph showing the degree of contribution of the auto-fluorescence from each lens unit of the objective lens and the amount of auto-fluorescence of the entire objective lens in the case where the low-fluorescence glass is used for the first and seventh lens units, in comparison with the case where the low-fluorescence glass is not used for the first and seventh lens units.

### DETAILED DESCRIPTION OF THE PREFERRED EMBODIMENTS

Japanese Patent Kokai No. Hei 11-106233 proposes optical glass in which the amount of platinum contained in the glass is reduced to 10 ppm or less and thereby the intensity of fluorescent light produced by ultraviolet excitation is decreased. It also proposes optical glass in which its composition is made so that arsenic and antimony are not substantially contained in the glass, and thereby the intensity of fluorescent light produced by ultraviolet excitation of platinum contained in the glass is decreased. In this prior art reference, it is described that the optical glass with a platinum content of 10 ppm or less, mentioned above, can be realized in such a way that in the use of a process of admitting a glass raw material to a platinum crucible to melt platinum, the mixing ratio of platinum to glass is lowered (for example, by the introduction of inert gases such as nitrogen and argon or by low-temperature melt, the mixing ratio of a platinum gas from a gas phase is lowered, or by the design improvement or by low-temperature melt of the platinum crucible, the mixing ratio of platinum from the platinum crucible is lowered).

To prevent the mixing of platinum in the manufacture of the optical glass, for example, the technique of using a crucible made with a substance other than platinum, such as a quartz crucible, is known. However, depending on the kind of the glass raw material using a rare-earth element such as lanthanum (La), the optical glass develops defects such as striae, is unsuitable for mass production, and comes expensive. Thus, in order to mass-produce optically homogeneous optical glass at low cost, it is essential to use the platinum crucible. When the platinum crucible is used to produce the optical glass, however, the mixing of platinum of a number of ppm in the optical glass is not avoided.

When the composition is made so that arsenic and antimony are not substantially contained in the glass, the intensity of fluorescent light produced by ultraviolet excitation of platinum contained in the glass can be decreased. However, to promote the elimination of bubbles in the glass, debubbling agents such as arsenic and antimony must be often added into optical glass.

In recent high-precision instruments for fluorescence observations and measurements, when the platinum content of optical glass is as high as 10 ppm, the noise of auto-fluorescence is produced to deteriorate qualities of the instruments. As such, in the platinum content of the optical glass, it is not allowable that the upper limit is as high as 10 ppm as described in the above prior art reference, and it must be kept to 1 ppm or less.

The technique described in the above prior art reference proposes that the intensity of auto-fluorescence in the optical glass is decreased, but fails to consider that the intensity of auto-fluorescence of the entire optical system having optical elements is efficiently reduced in the fluorescence observing apparatus, such as the fluorescence microscope, and the fluorescence measuring apparatus.

However, the present inventors have devoted attention to the degree of contribution of the intensities of auto-fluorescence emanating from individual optical elements provided in the optical system of the fluorescence observing apparatus or the fluorescence measuring apparatus to the intensity of auto-fluorescence produced in the entire optical system, and have considered which of optical elements provided in the fluorescence observing apparatus and the fluorescence measuring apparatus to be constructed as a low-fluorescence lens with a platinum content of 1 ppm or less can effectively eliminate the noise caused by auto-fluorescence in the entire optical system. In this way, the present invention has been completed. What follows is a description of the process of its introduction.

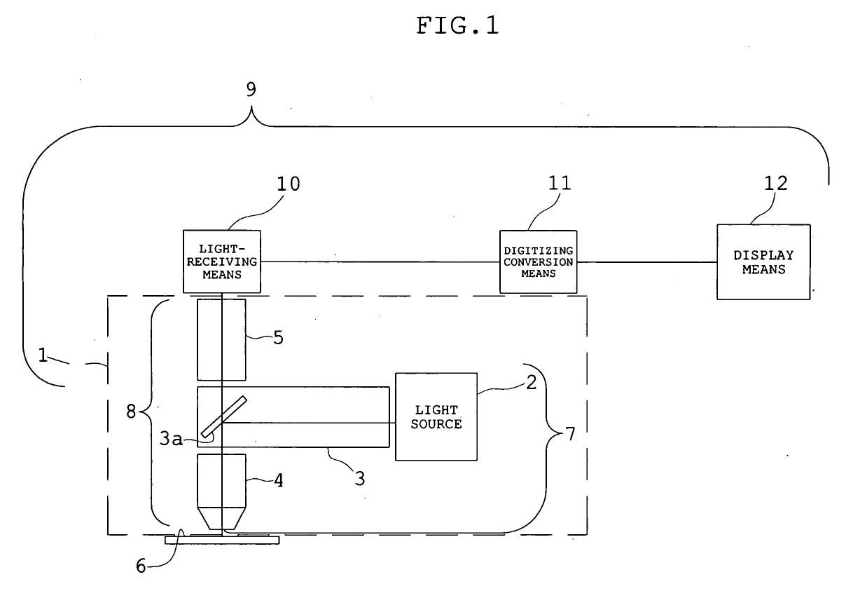

FIG. 1 is a schematic explanatory view showing diagrammatically a fundamental structure of the fluorescence observing apparatus and the fluorescence measuring apparatus.

A fluorescence observing apparatus 1 shown in FIG. 1 is constructed as a fluorescence microscope that has a light source 2 irradiating excitation light, an illumination optical system 3, an objective lens 4, and an imaging lens 5. The illumination optical system 3 has a deflecting member 3a for conducting the excitation light from the light source 2 to a specimen 6. The deflecting member 3a is such as to reflect the excitation light and to transmit fluorescent light from the specimen 6.

In the fluorescence observing apparatus 1, the light source 2, the illumination optical system 3, and the objective lens 4 constitute an illumination system 7 for irradiating the specimen 6 with the excitation light. The objective lens 4 and the imaging lens 5 constitute an observation system 8 for observing the fluorescent light from the specimen 6. Also, although the imaging lens 5 is simply shown in FIG. 1, it may be constructed to have an eyepiece optical system that observation with a naked eye is possible, an imaging optical system that imaging by an image sensor is possible, and a separating means for directing light to these optical systems.

A fluorescence measuring apparatus 9 includes the fluorescence observing apparatus 1, a light-receiving means 10 having an image sensor located at the position of observation of the observation system 8 in the fluorescence observing apparatus 1, a digitizing conversion means 11 for digitizing fluorescence information received by the image sensor, and a display means 12 for displaying the fluorescence information digitized by the digitizing conversion means 11. The fluorescence measuring apparatus is aimed principally at digitizing received fluorescence information to be handled as quantitative data, so that a fundamental optical structure is the same as that of the fluorescence observing apparatus such as the fluorescence microscope and thus the structure of the fluorescence microscope can be applied as it is.

In the fluorescence observing apparatus and the fluorescence measuring apparatus, an optical element that the noise caused by auto-fluorescence affects the observation and measurement is one located on the optical path common to the illumination system for irradiating the specimen with excitation light and the observation system for observing fluorescent light from the specimen. In the fluorescence observing apparatus 1 and the fluorescence measuring apparatus 9 shown in FIG. 1, the objective lens 4 corresponds to this optical element. The objective lens used in the fluorescence observing apparatus and the fluorescence measuring apparatus of this kind is generally constructed with a plurality of lens units.

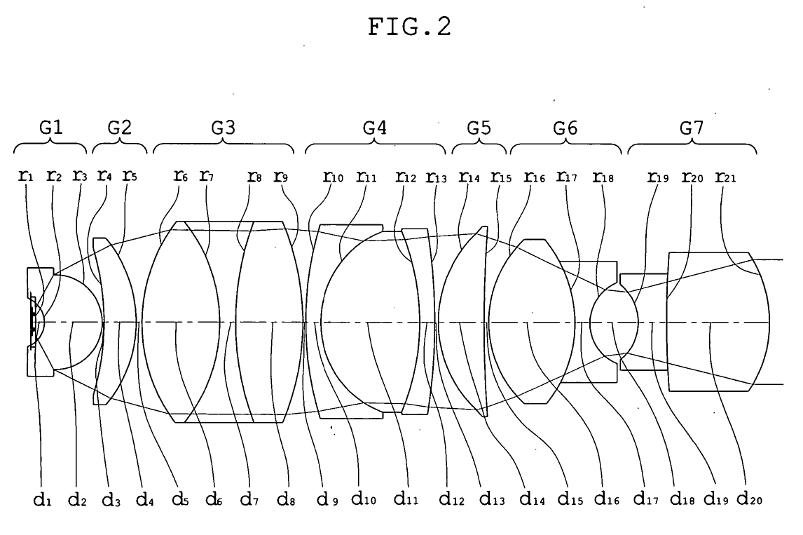

Thus, by using the objective lens shown in FIG. 2 as an example of the objective lens 4 applicable to the fluorescence observing apparatus 1 (or the fluorescence apparatus 9), the inventors have measured the intensities of auto-fluorescence produced in individual lens units (and individual lens elements) and at the same time, have considered the degree of contribution of the intensities of auto-fluorescence produced in individual lens units to the entire objective lens.

FIG. 2 is a sectional view showing an example of the arrangement of the objective lens 4, developed along the optical axis, used in both the illumination system 7 and the observation system 8 of the fluorescence observing apparatus 1 (or the fluorescence measuring apparatus 9) shown in FIG. 1 to measure the intensity of auto-fluorescence in a process introducing the present invention.

The objective lens shown in FIG. 2 includes seven lens units G1-G7.

A first lens unit G1 is constructed with a cemented doublet consisting of a piano-convex lens and a meniscus lens with a concave surface facing the object side. A second lens unit G2 has a positive meniscus lens with a concave surface facing the object side. A third lens unit G3 is constructed with a cemented triplet consisting of a biconvex lens, a biconcave lens, and a biconvex lens. A fourth lens unit G4 is constructed with a cemented triplet consisting of a negative meniscus lens with a convex surface facing the object side, a biconvex lens, and a negative meniscus lens with a concave surface facing the object side. A fifth lens unit G5 has a positive meniscus lens with a convex surface facing the object side. A sixth lens unit G6 is constructed with a cemented doublet consisting of a biconvex lens and a biconcave lens. A seventh lens unit G7 is constructed with a cemented doublet consisting of a biconcave lens and a biconvex lens.

Subsequently, in the objective lens shown in FIG. 2 and the fluorescence observing apparatus 1 (or the fluorescence measuring apparatus 9) shown in FIG. 1, lens data of the objective lens and the imaging lens combined with the objective lens are listed below. In the data, r₁, r₂, . . . denote radii of curvature of individual lens surfaces indicated in order from the object side (here, the specimen side); d₁, d₂, . . . denote spacings between individual lens surfaces indicated in order from the object side; n_{d1}, n_{d2}, . . . denote refractive indices, at the d line, of individual lenses indicated in order from the object side; v_{d1}, v_{d2}, . . . denote Abbe's numbers of individual lenses indicated in order form the object side; and h₁, h₂, . . . denote ray heights where a ray of light of the maximum numerical aperture passes through individual lens surfaces.

Also, in the objective lens shown in FIG. 2, a focal length f=3, a magnification=60×, a numerical aperture NA=1.4, and a working distance wd=0.14. The objective lens of FIG. 2 is of an oil immersion type, and the refractive index and Abbe's number of oil to be used are n_{d}=1.51548 and v_{d}=43.10, respectively. The refractive index, Abbe's number, and thickness of a cover glass are n_{d}=1.52100, v_{d}=56.02, d=0.17 mm, respectively.

A distance between the objective lens and the imaging lens which are applied to the fluorescence observing apparatus 1 (or the fluorescence measuring apparatus 9) is 56 mm.

Numerical Data (Objective Lens)

| Lens unit | Radius of curvature | Surface spacing | Refractive index | Abbe's number | Maximum ray height |
|---|---|---|---|---|---|
| 1st lens unit | r₁ = ∞ | d₁ = 0.6 | n_{d1} = 1.51633 | ν_{d1} = 64.14 | h₁ = 0.738 |
| | r₂ = −1.8192 | d₂ = 3.84 | n_{d2} = 1.883 | ν_{d2} = 40.76 | h₂ = 1.165 |
| | r₃ = −3.2177 | d₃ = 0.1 | | | h₃ = 3.217 |
| 2nd lens unit | r₄ = −20.4857 | d₄ = 2.1418 | n_{d4} = 1.56907 | ν_{d4} = 71.3 | h₄ = 4.744 |
| | r₅ = −8.7588 | d₅ = 0.3 | | | h₅ = 5.181 |
| 3rd lens unit | r₆ = 11.0685 | d₆ = 5.3 | n_{d6} = 1.497 | ν_{d6} = 81.54 | h₆ = 6.329 |
| | r₇ = −10.4406 | d₇ = 1 | n_{d7} = 1.6134 | ν_{d7} = 43.84 | h₇ = 6.251 |
| | r₈ = 18.9938 | d₈ = 4.5 | n_{d8} = 1.43875 | ν_{d8} = 94.93 | h₈ = 6.237 |
| | r₉ = −17.4921 | d₉ = 0.15 | | | h₉ = 6.324 |
| 4th lens unit | r₁₀ = 25.511 | d₁₀ = 1 | n_{d10} = 1.6765 | ν_{d10} = 37.54 | h₁₀ = 6.081 |
| | r₁₁ = 6.4981 | d₁₁ = 6.58 | n_{d11} = 1.43875 | ν_{d11} = 94.93 | h₁₁ = 5.519 |
| | r₁₂ = −16.9602 | d₁₂ = 1 | n_{d12} = 1.74 | ν_{d12} = 31.71 | h₁₂ = 5.638 |
| | r₁₃ = −37.6734 | d₁₃ = 0.3 | | | h₁₃ = 5.789 |
| 5th lens unit | r₁₄ = 8.7662 | d₁₄ = 3.1 | n_{d14} = 1.456 | ν_{d14} = 90.28 | h₁₄ = 5.971 |
| | r₁₅ = 145.8837 | d₁₅ = 0.15 | | | h₁₅ = 5.769 |
| 6th lens unit | r₁₆ = 7.866 | d₁₆ = 5.734 | n_{d16} = 1.618 | ν_{d16} = 63.33 | h₁₆ = 5.13 |
| | r₁₇ = −8.8483 | d₁₇ = 1 | n_{d17} = 1.6765 | ν_{d17} = 37.54 | h₁₇ = 3.554 |
| | r₁₈ = 3.0648 | d₁₈ = 3.2 | | | h₁₈ = 2.284 |
| 7th lens unit | r₁₉ = −3.4631 | d₁₉ = 2.0409 | n_{d19} = 1.74 | ν_{d19} = 31.71 | h₁₉ = 2.127 |
| | r₂₀ = 270.3729 | d₂₀ = 6.7011 | n_{d20} = 1.80518 | ν_{d20} = 25.42 | h₂₀ = 2.839 |
| | r₂₁ = −8.4836 | | | | h₂₁ = 4.206 |

Numerical Data (Imaging Lens)

| Radius of curvature | Surface spacing | Refractive index | Abbe's number | Maximum ray height |
|---|---|---|---|---|
| r₁ = 68.7541 | d₁ = 7.7321 | n_{d1} = 1.48749 | ν_{d1} = 70.21 | h₁ = 14.114 |
| r₂ = −37.5679 | d₂ = 3.4742 | n_{d2} = 1.8061 | ν_{d2} = 40.95 | h₂ = 14.034 |
| r₃ = −102.8477 | d₃ = 0.6973 | | | h₃ = 14.317 |
| r₄ = 84.3099 | d₄ = 6.0238 | n_{d4} = 1.834 | ν_{d4} = 37.17 | h₄ = 14.274 |
| r₅ = −50.71 | d₅ = 3.0298 | n_{d5} = 1.6445 | ν_{d5} = 40.82 | h₅ = 14.072 |
| r₆ = 40.6619 | | | | h₆ = 13.095 |

Subsequently, auto-fluorescence values of individual lenses constituting the objective lens are shown in Table 1. In accordance with “Method of measuring fluorescence intensity of optical glass” specified by Japanese Optical Glass Industrial Standard, the measurements of auto-fluorescence of individual lenses are made by setting an excitation wavelength to 480 nm.

TABLE 1
Glass auto-fluorescence values

| | | | Auto- |
|---|---|---|---|
| Lens unit | Refractive index | Abbe's number | fluorescence value |
| 1st lens unit | 1.51633 | 64.14 | 2 |
| | 1.883 | 40.76 | 7 |
| 2nd lens unit | 1.56907 | 71.3 | 1 |
| 3rd lens unit | 1.497 | 81.54 | 1 |
| | 1.6134 | 43.84 | 2 |
| | 1.43875 | 94.93 | 1 |
| 4th lens unit | 1.6765 | 37.54 | 2 |
| | 1.43875 | 94.93 | 1 |
| | 1.74 | 31.71 | 5 |
| 5th lens unit | 1.456 | 90.28 | 1 |
| 6th lens unit | 1.618 | 63.33 | 1 |
| | 1.6765 | 37.54 | 2 |
| 7th lens unit | 1.74 | 31.71 | 5 |
| | 1.80518 | 25.42 | 4 |

In the present invention, glass with an auto-fluorescence value of less than 3 is defined as low-fluorescence glass.

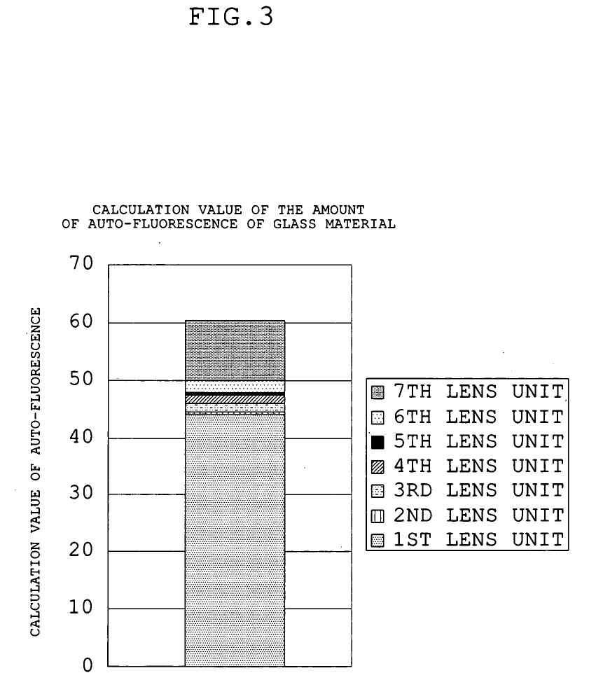

Next, Table 2 shows the degrees of contribution of auto-fluorescence from individual lens units of the objective lens (a relative magnitude relationship between the intensities of auto-fluorescence) where the objective lens shown in FIG. 2, the numerical data, and Table 1 is combined with the imaging lens shown in the numerical data to construct the fluorescence observing apparatus. The amount of auto-fluorescence of the entire objective lens graphed in accordance with the values of Table 2 is shown in FIG. 3.

TABLE 2
Degrees of contribution of auto-fluorescence from
individual lens units of objective lens

| Lens unit | Degree of contribution |
|---|---|
| 1st lens unit | 44 |
| 2nd lens unit | 0.4 |
| 3rd lens unit | 1.5 |
| 4th lens unit | 1.5 |
| 5th lens unit | 0.3 |
| 6th lens unit | 2.2 |
| 7th lens unit | 10.3 |

As shown in Table 2, the intensities of the auto-fluorescence are considerably high in the first lens unit and the last lens unit and are not high in the intermediate lens units.

This is because a high-magnification objective lens is such that illumination is cast on the pupil of the objective lens and an illumination light beam follows nearly the same path as an imaging light beam. For this, it is conceivable that illumination light is collected in the first lens unit and thereby auto-fluorescence is produced significantly. In addition, the first lens unit is closest to a specimen surface (a sample surface). Therefore, auto-fluorescence emanating from the first lens unit efficiently reaches the image plane. As a result, it is conceivable that the proportion of auto-fluorescence produced in the first lens unit to that produced in the entire objective lens becomes high. Moreover, the first lens unit is generally made with a high-index glass material in order to correct axial aberrations (spherical aberration and chromatic aberration). It is thus conceivable that the production of the auto-fluorescence becomes pronounced.

The last lens unit is made with a high-index and high-dispersion glass material as a convex lens in order to correct off-axis aberrations (coma and chromatic aberration of magnification). It is thus conceivable that the production of the auto-fluorescence becomes pronounced.

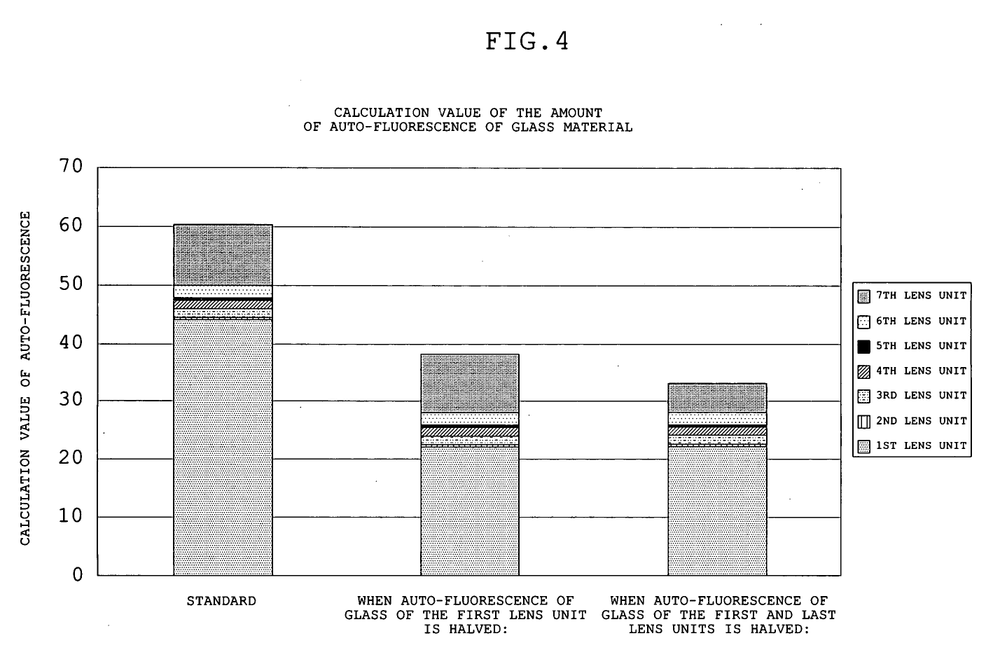

Hence, the present inventors simulate the degree of contribution of auto-fluorescence from individual lens units of the objective lens and the amount of auto-fluorescence of the entire objective lens in the case where the first lens unit that is the most object-side lens unit in the objective lens shown in FIG. 2 is constructed with lenses using low-fluorescence glass and in the case where the seventh lens unit that is the lens unit farthest away from an object is also constructed with lenses using low-fluorescence glass, and compare the case where the low-fluorescence glass is not used, assuming it as a standard. Comparison results of this are shown in Table 3. The amount of auto-fluorescence of the entire objective lens graphed in accordance with the values of Table 3 is shown in FIG. 4.

TABLE 3
Comparison between degrees of contribution of auto-fluorescence
from individual lens units of objective lens

| | | When auto- | |
|---|---|---|---|
| | | fluorescence | |
| | | of glass | When auto-fluorescence of |
| | | of the first lens | glass of the first lens unit and |
| Lens unit | Standard | unit is halved: | the last lens unit is halved: |
| 1st lens unit | 44 | 22 | 22 |
| 2nd lens unit | 0.4 | 0.4 | 0.4 |
| 3rd lens unit | 1.5 | 1.5 | 1.5 |
| 4th lens unit | 1.5 | 1.5 | 1.5 |
| 5th lens unit | 0.3 | 0.3 | 0.3 |
| 6th lens unit | 2.2 | 2.2 | 2.2 |
| 7th lens unit | 10.5 | 10.5 | 5.1 |

As shown in FIGS. 3 and 4, when the first lens unit that is the most object-side lens unit in the objective lens is constructed with lenses using the low-fluorescence glass, the influence of the noise caused by the auto-fluorescence can be efficiently lessened. When the seventh lens unit that is the lens unit farthest away from the object is constructed with lenses using the low-fluorescence glass, it is seen that the influence of the noise caused by the auto-fluorescence can be more efficiently lessened.

Thus, as the fluorescence observing apparatus and the fluorescence measuring apparatus of the present invention, it has been considered to use low-fluorescence glass for at least one optical element used in both the illumination system and the observation system, and more specifically, to use the low-fluorescence glass for the most specimen-side optical element (for example, the first lens unit of the objective lens 4 shown in the example of FIG. 2), of a plurality of optical elements used both the illumination system and the observation system (for example, a plurality of lens units constituting the objective lens 4 in the example of FIG. 1). When the optical system is constructed as mentioned above, the influence of the noise by the auto-fluorescence can be efficiently lessened, and a high-precision and high-quality fluorescence observing apparatus and fluorescence measuring apparatus can be obtained.

As the fluorescence observing apparatus and the fluorescence measuring apparatus of the present invention, in addition to the above construction, it has also been considered to use the low-fluorescence glass for an optical element farthest away from the specimen (for example, the seventh lens unit of the objective lens 4 in the example of FIG. 2), of a plurality of optical elements used in both the illumination system and the observation system (for example, a plurality of lens units constituting the objective lens 4 in the example of FIG. 1). When the optical system is constructed as mentioned above, the influence of the noise by the auto-fluorescence can be more efficiently lessened, and a higher-precision and higher-quality fluorescence observing apparatus and fluorescence measuring apparatus can be obtained.

In the present invention, the low-fluorescence glass has a platinum content of less than 1 ppm.

As described above, when the platinum content of the optical element used in both the excitation illumination and the observation and measurement is as high as 10 ppm, the noise of the auto-fluorescence is produced to cause the problems of qualities for observation and measurement apparatuses. When the low-fluorescence glass has a platinum content of less than 1 ppm, a high-precision fluorescence observing apparatus and fluorescence measuring apparatus are obtained. Also, in order to reduce the platinum content of the glass to less than 1 ppm, it is good practice to make the optical glass by using the following means:

(1) A quartz crucible is used, without using platinum. Alternatively, glass of high melting point, such as quartz glass, is used on the surface of a platinum crucible to extremely decrease the mixing of platinum.

(2) The glass composition and the manufacturing process are optimized such that even when the melting time is shortened, or even when the melting temperature is reduced, striae is not produced.

(3) The improvement of the platinum crucible is carried out.

(4) An inert gas for preventing the mixing from the gas phase is injected. In particular, it is desirable that an argon gas is used as the inert gas to be injected because bubbles and striae do not remain. A nitrogen gas may be used.

In the present invention, when the low-fluorescence glass is manufactured with a material containing at least platinum through a process of melting a glass raw material, it is manufactured though a process of bubbling melting glass by one of phosphorus oxy-chloride (POCl₃), thionyl chloride (SOCl₂), phosphorus trichloride (PCl₃), and carbon tetrachloride (CCl₄). By doing so, even though platinum is dissolved from the platinum crucible in a melting state of the glass raw material and the platinum content is 1 ppm or more, the melting glass is bubbled by a chloride like phosphorus oxychloride (POCl₃), thionyl chloride (SOCl₂), phosphorus trichloride (PCl₃), or carbon tetrachloride (CCl₄), and thereby a platinum colloid to be contained is ionized and can be eliminated.

In the present invention, the low-fluorescence glass may be manufactured with a glass raw material in which impurities are kept to less than 1 ppm.

When a raw material in which an impurity (notably, a transition metal such as iron) contained in silica is reduced is used as the glass raw material, the noise by fluorescent light can be lessened and the performance of the fluorescence observation and the fluorescence measurement can be improved.

In the present invention, it is desirable that the low-fluorescence glass is manufactured through a process of pickling the glass raw material with acid. When the raw material in which an impurity (notably, a transition metal such as iron) contained in silica is reduced through such a process is used as the glass raw material, the noise by the auto-fluorescence can be lessened and the performance of the fluorescence observation and the fluorescence measurement can be improved. Even though impurities are originally contained at some ratio in the glass raw material, the glass raw material is pickled with acid (for example, hydrochloric acid or nitric acid), and thereby the component of the transition metal responsible for the auto-fluorescence is ionized and dissolved. This brings about the effect of lowering the purity of impurities in the glass raw material, and makes the fluorescence noise of the manufactured glass low.

Using the low-fluorescence glass for the first and seventh lens units in the objective lens shown in FIG. 2, the embodiments of the present invention in which the fluorescence observing apparatus (or the fluorescent measuring apparatus) of FIG. 1 is constructed will be explained below. Also, the fluorescence observing apparatus (or the fluorescence measuring apparatus), a fundamental optical structure of the objective lens, except for glass material, and the optical structure of the imaging lens in each of the embodiments are the same as those shown in FIG. 2 and in the lens data of the objective lens and the imaging lens.

Embodiment 1

In the fluorescence observing apparatus (or the fluorescent measuring apparatus) of Embodiment 1, glass manufactured by melting an Si—B—Na—K based glass raw material in the quartz crucible to take out a striae-free center portion is used for lenses of the first lens unit G1 and the seventh lens unit G7 of the last lens unit in the objective lens 4. In the glass thus obtained, the impurity content is less than 1 ppm and the auto-fluorescence is very low. Hence, the fluorescence observing apparatus (or the fluorescent measuring apparatus) in which the influence of the noise by the auto-fluorescence can be efficiently lessened is obtained.

Embodiment 2

In the fluorescence observing apparatus (or the fluorescent measuring apparatus) of Embodiment 2, glass manufactured through the processes of melting an La—Zr—Ta—B—Si based glass raw material in the platinum crucible, introducing a phosphorus oxychloride (POCl₃) gas into melting glass, and bubbling the melting glass is used for lenses of the first lens unit G1 and the seventh lens unit G7 of the last lens unit in the objective lens 4. The auto-fluorescence of the glass thus obtained is very low, and the fluorescence observing apparatus (or the fluorescent measuring apparatus) in which the influence of the noise by the auto-fluorescence can be efficiently lessened is obtained.

### COMPARATIVE EXAMPLE 1

As Comparative example 1 relative to Embodiment 2, glass manufactured by melting the same glass raw material as in Embodiment 2 in the platinum crucible, without the bubbling process, is used for lenses of the first lens unit G1 and the seventh lens unit G7 of the last lens unit in the objective lens 4. The noise by the auto-fluorescence of the glass thus obtained becomes very pronounced and the influence of the noise by the auto-fluorescence cannot be lessened.

### COMPARATIVE EXAMPLE 2

As Comparative example 2 relative to Embodiment 2, glass manufactured through the processes of melting the same glass raw material as in Embodiment 2 in the quartz crucible and of bubbling the melting glass is used for lenses of the first lens unit G1 and the seventh lens unit G7 of the last lens unit in the objective lens 4. The glass manufactured by using the quartz crucible produces the striae and cannot be entirely used as lenses.

Embodiment 3

In the fluorescence observing apparatus (or the fluorescent measuring apparatus) of Embodiment 3, a raw material which is few in impurity (for example, silicon dioxide), made by KOJUNDO CHEMICAL LABORATORY CO., LTD, is used and glass manufactured through the processes of melting the Si—B—Na—K based glass material in the platinum crucible and of bubbling the melting glass is used for lenses of the first lens unit G1 and the seventh lens unit G7 of the last lens unit. The fluorescence of the glass thus obtained is very low and the fluorescence observing apparatus (or the fluorescent measuring apparatus) in which the influence of the noise by the auto-fluorescence can be efficiently lessened is obtained.

Embodiment 4

In the fluorescence observing apparatus (or the fluorescent measuring apparatus) of Embodiment 4, a commercially available raw material which is comparatively few in impurity (for example, silicon dioxide of 99.9% pure) is used for lenses of the first lens unit G1 and the seventh lens unit G7 of the last lens unit in the objective lens 4, and the raw material is immersed in 1N hydrochloric acid and then ultrasonically cleaned for 24 hours. The cleaned raw material thus obtained is dried and used as the glass material. The glass is manufactured through the processes of melting the Si—B—Na—K based glass material in the platinum crucible and of bubbling the melting glass. The fluorescence of the glass thus obtained is very low and the fluorescence observing apparatus (or the fluorescent measuring apparatus) in which the influence of the noise by the auto-fluorescence can be efficiently lessened is obtained.

The fluorescence observing apparatus and the fluorescence measuring apparatus of the present invention are useful for the fields of biology and medicine that need accurate observations and measurements of faint fluorescent light in a wide range.

1. A fluorescence observing apparatus comprising:
an illumination system for irradiating a specimen with exciting light; and
an observation system for observing fluorescent light emanating from the specimen,
wherein low-fluorescence glass is used for at least one optical element used in both the illumination system and the observation system.

2. A fluorescence observing apparatus according to claim 1, having a plurality of optical elements used in both the illumination system and the observation system so that the low-fluorescence glass is used for a most specimen-side optical element of the plurality of optical elements used in both the illumination system and the observation system.

3. A fluorescence observing apparatus according to claim 1, having a plurality of optical elements used in both the illumination system and the observation system so that the low-fluorescence glass is used for a most image-side optical element of the plurality of optical elements used in both the illumination system and the observation system.

4. A fluorescence observing apparatus according to claim 1, having an objective lens composed of a plurality of lens units used in both the illumination system and the observation system so that the low-fluorescence glass is used for lenses constituting a most specimen-side lens unit of the objective lens.

5. A fluorescence observing apparatus according to claim 1, having an objective lens composed of a plurality of lens units used in both the illumination system and the observation system so that the low-fluorescence glass is used for lenses constituting a most image-side lens unit of the objective lens.

6. A fluorescence observing apparatus according to claim 3, having an objective lens composed of a plurality of lens units used in both the illumination system and the observation system so that the low-fluorescence glass is used for lenses constituting a most image-side lens unit of the objective lens.

7. A fluorescence observing apparatus according to claim 4, having an objective lens composed of a plurality of lens units used in both the illumination system and the observation system so that the low-fluorescence glass is used for lenses constituting a most image-side lens unit of the objective lens.

8. A fluorescence observing apparatus according to claim 1, wherein the low-fluorescence glass has a platinum content of less than 1 ppm.

9. A fluorescence observing apparatus according to claim 3, wherein the low-fluorescence glass has a platinum content of less than 1 ppm.

10. A fluorescence observing apparatus according to claim 4, wherein the low-fluorescence glass has a platinum content of less than 1 ppm.

11. A fluorescence observing apparatus according to claim 5, wherein the low-fluorescence glass has a platinum content of less than 1 ppm.

12. A fluorescence observing apparatus according to claim 1, wherein the low-fluorescence glass is manufactured through a process of using a material containing at least platinum to melt a glass raw material and is manufactured through a process of bubbling melting glass by one of phosphorus oxychloride (POC1₃), thionyl chloride (SOC1₂), phosphorus trichloride (PC1₃), and carbon tetrachloride (CC1₄).

13. A fluorescence observing apparatus according to claim 3, wherein the low-fluorescence glass is manufactured through a process of using a material containing at least platinum to melt a glass raw material and is manufactured through a process of bubbling melting glass by one of phosphorus oxychloride (POC1₃), thionyl chloride (SOC1₂), phosphorus trichloride (PC1₃), and carbon tetrachloride (CC1₄).

14. A fluorescence observing apparatus according to claim 4, wherein the low-fluorescence glass is manufactured through a process of using a material containing at least platinum to melt a glass raw material and is manufactured through a process of bubbling melting glass by one of phosphorus oxychloride (POCl₃), thionyl chloride (SOC1₂), phosphorus trichloride (PC1₃), and carbon tetrachloride (CC1₄).

15. A fluorescence observing apparatus according to claim 5, wherein the low-fluorescence glass is manufactured through a process of using a material containing at least platinum to melt a glass raw material and is manufactured through a process of bubbling melting glass by one of phosphorus oxychloride (POC1₃), thionyl chloride (SOC1₂), phosphorus trichloride (PC1₃), and carbon tetrachloride (CC1₄).

16. A fluorescence observing apparatus according to claim 1, wherein the low-fluorescence glass is manufactured by using a glass raw material in which an impurity content is kept to less than 1 ppm.

17. A fluorescence observing apparatus according to claim 3, wherein the low-fluorescence glass is manufactured by using a glass raw material in which an impurity content is kept to less than 1 ppm.

18. A fluorescence observing apparatus according to claim 4, wherein the low-fluorescence glass is manufactured by using a glass raw material in which an impurity content is kept to less than 1 ppm.

19. A fluorescence observing apparatus according to claim 5, wherein the low-fluorescence glass is manufactured by using a glass raw material in which an impurity content is kept to less than 1 ppm.

20. A fluorescence observing apparatus according to claim 1, wherein the low-fluorescence glass is manufactured through a process of pickling a glass raw material with acid.

21. A fluorescence observing apparatus according to claim 3, wherein the low-fluorescence glass is constructed of glass manufactured through a process of pickling a glass raw material with acid.

22. A fluorescence observing apparatus according to claim 4, wherein the low-fluorescence glass is manufactured through a process of pickling a glass raw material with acid.

23. A fluorescence observing apparatus according to claim 5, wherein the low-fluorescence glass is manufactured through a process of pickling a glass raw material with acid.

24. A fluorescence measuring apparatus comprising:
a fluorescence observing apparatus according to claim 1;
an image sensor located at a position of observation of an observation system; digitizing conversion means of digitizing fluorescence information received by the image sensor; and
display means of displaying the fluorescence information digitized by the digitizing conversion means.
